(19) United States
(12) Patent Application Publication
(10) Pub. No.: US 2005/0169254 A1
(43) Pub. Date: Aug. 4, 2005

(54) Data relay apparatus, data relay method, data relay program, service selection apparatus, service selection method and service selection program

(75) Inventors: Toshihiko Kurita, Kawasaki (JP); Hirokazu Iwakura, Kawasaki (JP); Hiroyuki Yamashima, Kawasaki (JP); Eiki Iwata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/070,672

(22) Filed: Mar. 3, 2005

Related U.S. Application Data
(63) Continuation of application No. PCT/JP03/04689, filed on Apr. 14, 2003.

(51) Int. Cl. H04L 12/66

(52) U.S. Cl. 370/352

(57) ABSTRACT

A data relay apparatus 1 effectively prevents degradation of data quality by selecting a server and a route according to the load information and is arranged between a plurality of servers and a client in order to relay a connection request from the client to one of the servers. The data relay apparatus 1 comprises an information collection section 2 that collects load information on the servers and load information on the respective routes from the data relay apparatus to the servers and a service selection section 5 that selects at least a server and a route to the server in response to the connection request from the client according to the load information collected by the information collection section 2.

### TECHNICAL FIELD

This invention relates to a data relay apparatus and the like that can be applied to an information communication system formed by combining client servers and networks. More particularly, the present invention relates to a data relay apparatus, a data relay method and a data relay program to be arranged between a plurality of servers and a client to relay a connection request to one of the servers from the client. The present invention also relates to a service selection apparatus, a service selection method and a service selection program for selecting a server from a plurality of servers and a route to that server.

### BACKGROUND ART

As a result of the sophisticated development of information communications and information services in recent years, server load distribution control techniques have been and being used to improve the performance of information communication systems and information service systems. With such a technique, a plurality of servers are provided with same information and connection requests for accessing the information (to be referred to as information requests hereinafter) made by using a same and single information address (e.g., virtual IP (VIP) address) are assigned to one of the plurality of servers. With the server load distribution control technique, it is necessary for a large system having user sites and server sites geographically distributed over a large area to realize an efficient load assignment among the servers and the server sites that are distributed over a large geographical area. It is desired to effectively exploit the resources and maintain the quality of service by optimally selecting a server and a route for getting to the server among a plurality of candidate servers and candidate routes for the load assignment on the basis of an established policy and the load information that is periodically collected.

Such a demand particularly comes from systems as described below by referring to FIG. 20 of the accompanying drawings.

(a) Corporate Information Systems

A corporate information system is a system combining geographically distributed information system sites.

(b) Distributed Idc (Internet Data Center)

A distributed IDC system is a system combining local IDCs or local IDCs and a central IDC.

(c) Carrier Systems

A carrier system is a system combining IP carrier centers.

GWs (gateways: data relay apparatus) in FIG. 20 are responsible for the load assignment among the servers distributed over a large geographical area.

Conventional techniques for building a system of any of the above listed categories include the following.

(1) Large Area Load Distribution Technique

This technique is designed to distribute a load among the servers and the server sites arranged in a large geographical area. Generally, the DNS round robin method of assigning a load by sequentially transferring a DNS response among a plurality of servers and the server load method of assigning a load to the server currently having the smallest load by periodically collecting information on the loads of a plurality of servers are used.

With the DNS round robin method, the DNS response is transferred to the servers in a predetermined sequence without considering the loads of the servers and the load of the route. With the server load method, the server to whom the load is to be assigned is determined only on the basis of the current loads of the servers without considering the load of the route. With either of these methods, it is not possible to select a route and only the single route that is unequivocally determined by the IP routing as described below.

(2) Traffic Engineering

This is a technique for distributing loads among routes. With this technique, each route is monitored on the network level and if the route is judged to be congested, the load of the route is partly assigned to a substitute route. This is a technique of optimizing only the route load and the situations of the servers and individual flows of information are not considered to control the load assignment.

(3) IP Routing

With this technique, route information is exchanged among routers and a route that minimizes a single evaluation reference value (e.g., the number of hops) is continuously used. Generally, more than two routes are not considered for use.

(4) QOSPF

This technique relates to a routing protocol that is based on a number of evaluation references relating to the Qos (quality of service). While this technique deals with a plurality of evaluation references on a network, which rout is to be selected is determined depending on if each individual evaluation reference meets certain conditions or not (if it is found within a predetermined range or not). Generally, it is not possible to unequivocally determine a solution and not a particularly bad one will be selected.

However, the above listed known techniques are accompanied by the following problems. The service to be provided is selected only on the basis of the route load or the load information of the servers by means of any of the techniques of (2) traffic engineering and (3) IP routing that are adapted to select the service to be provided only on the basis of the route and the technique of (1) server load method that is adapted to select the service to be provided only on the basis of the load information of the servers. Thus, since the service to be provided is selected only on the basis of either the route load or the server load, there is no knowing if the server load or the route load, whichever appropriate, of the selected service is excessively large or not. Then, the selected service can be degraded if either the server load or the route load is excessively large. If, for example, the service (server and route) to be provided is selected only on the load information of the servers, the service system keeps on using the route to provide the service regardless if the route is congested or not. In other words, if the route is congested and a less congested substitute route is available, the service system does not assign the substitute route to provide the service and hence the selected service can be degraded. In short, it is not possible to effectively exploit the resources with a technique of selecting the service to be provided only on the basis of the load information of the routes or the load information of the servers.

Additionally, if the service to be provided is selected on the basis of a plurality of evaluation references with the technique of (4) QOSPF, if each individual evaluation reference meets certain conditions or not is checked to select the service. However, there are no unified guidelines for dealing with the plurality of evaluation references. In other words, it is not feasible to simply compare combinations of evaluation references and hence it is not possible to unequivocally select the service to be provided. Additionally, since each evaluation reference is judged individually, this technique will inevitably involve a number of judgments for branching and a large volume of computations, which may be time consuming to complete.

Additionally, with any of the above-described known techniques, there can be discrepancies between the collected load information and the current situation. Generally, the time intervals of collecting load information are relatively long (several seconds) and hence the load conditions may have been changed at a time in the intermediate period after the last load information collecting operation. In other words, the obtained load information may not be accurate at the current time.

In view of the above-identified problems, it is therefore the object of the present invention to provide a data relay apparatus, a data relay method and a data relay program and also a service selection apparatus, a service selection method and a service selection program that are adapted to firstly collect load information of one, two or more than two resources relating to each server and each route and subsequently comprehensively judge the plurality of pieces of load information to select the service (server and route) to be provided in order to effectively exploit the resources and maintain the quality of service.

### DISCLOSURE OF THE INVENTION

In an aspect of the present invention, the above object is achieved by providing a data relay apparatus to be arranged between a plurality of servers and a client in order to relay a connection request from the client to one of the servers, the apparatus comprising: an information collecting section for collecting load information on the servers and load information on the respective routes from the data relay apparatus to the servers; and a service selecting section for selecting at least a server and a route to the server in response to the connection request from the client according to the load information collected by the information collecting section.

With this arrangement, the data relay apparatus can collect load information on one, two or more than two resources relating to the servers and the routes and select the service (server and route) to be provided by comprehensively taking the collected plurality of pieces of load information into consideration in order to effectively exploit the resources and maintain the quality of service.

Preferably, in the data relay apparatus according to the invention, the service selecting section computes the remaining capacity ratio of each server and each route according to the load information and the product of multiplication of the obtained remaining capacity ratio of a server and that of a route for a plurality of combinations of a server and a route and selects at least a server and a route to the server according to the computed products of multiplication.

With this arrangement, it is possible to compute a single evaluation reference value (preference value) from a plurality of evaluation references on the basis of load information for the purpose of selecting the service (server and route) to be provided so that choices can be compared with each other with ease. Then, it is possible to select a service on the basis of the ratio of utilization of each resource, which is a server or a route, and hence assign services in such a way that the ratios of utilization of the resources may be made even. Additionally, choices can be compared with each other with ease on the basis of a single reference value when a number of evaluation references are combined.

Preferably, in the data relay apparatus according to the invention, the service selecting section acquires load information, or the change in the remaining capacity ratio, on a predetermined server and that of a route to the server in case of receiving a unit number of connection requests and computes the remaining capacity ratio according to the change in the remaining capacity ratio, the remaining capacity ratio according to the acquired load information and the change in the number of connection requests when receiving a connection request from the client.

With this arrangement, it is possible to predict the load condition of the server and that of the route at a point in the time intervals of collecting load information and hence it is possible to assign services more accurately in order to effectively exploit the resources and maintain the quality of service by selecting a service according to the predicted values.

Preferably, in the data relay apparatus according to the invention, the service selecting section computes the difference in the products of multiplication of the remaining capacity ratios before and after the reception of the connection request and selects at least a server and a route to the server according to the difference value.

With this arrangement, it is possible to extract the choice that will affect least the reduction in the remaining capacity ratio of all the resources as a result of assigning a service, or the choice that has the largest remaining resource. Note that this arrangement is adapted not to operate to make the ratios of utilization of the resources even but to operate to select the choice having the largest absolute remaining capacity in order to effectively exploit the resources if there is a difference in the absolute capacities of the resources.

Preferably, in the data relay apparatus according to the invention, the service selecting section computes and acquires the load information on a predetermined server and a route to the server or the change in the remaining capacity ratio in case of receiving a unit number of connection requests according to the respective differences between the load information and the number of connection requests collected at a first time point and the load information and the number of connection requests collected at the second time point.

With this arrangement, it is possible to compute the reduction in the remaining capacity ratio of each resource when receiving a connection request (information request) by feeding back the results obtained by actual measurements. Then, it is possible to rigorously predict the load condition of the server and that of the route if compared with a case where fixed values are used.

Preferably, in the data relay apparatus according to the invention, the service selecting section acquires the ratio of utilization of each of the resources related to the load information, weighting the resource utilization ratio by introducing function F, using the resource utilization ratio as parameter xi, and computes the remaining capacity ratio by means of 1−F(xi).

With this arrangement, it is possible to evaluate each choice by weighting the ratio of utilization of each resource. In other words, it is possible to raise or reduce the extent of influence when comparing the evaluation reference with other evaluation references. Thus, as a result, it is not necessary to deal with all the evaluation references equally and the influence of a preferential evaluation reference can be raised, while that of a non-preferential evaluation reference can be reduced, when making a judgment on a choice.

Preferably, the data relay apparatus according to the invention is adapted to monitor the product of multiplication of the remaining capacity ratio of a server and that of a route for a plurality of combinations of a server and a route and, if the monitored value falls under a predetermined value, it judges that the combined resources are congested and switches to another route for communication connection.

With this arrangement, if an established communication connection becomes congested under the influence of some other communication connections, it is possible to maintain the level of service quality by switching the route of the communication connection to some other less congested alternative route. Such an autonomous control operation can be realized with ease from a single reference value computationally determined from a plurality of pieces of load information (server information and route information).

Preferably, in the data relay apparatus according to the invention, the service selecting section selects a server and a route to the server according to policy information defining assignment of services.

With this arrangement, it is possible to select resources by giving priority to the policy or by giving priority to certain pieces of load information within the scope of the predefined policy so as to flexibly meet the requests of the user.

In the data relay apparatus according to the invention, the load information on servers may include at least the CPU load ratio, the disk occupancy ratio or the connection number and the load information on routes may include at least the operating band or the route delay. In a data relay apparatus according to the invention, the server may be an SLB server comprising a server load summarizing section for summarizing the load information from a plurality of application servers.

In another aspect of the present invention, there is provided a data relay method of a data relay apparatus arranged between a plurality of servers and a client in order to relay a connection request from the client to one of the servers, the method comprising: an information collecting step of collecting load information on the servers and load information on the respective routes from the data relay apparatus to the servers; and a service selecting step of selecting at least a server and a route to the server in response to the connection request from the client according to the load information collected by the information collecting step.

Preferably, the service selecting step includes a step of computing the remaining capacity ratio of each server and each route according to the load information, a step of computing the product of multiplication of the obtained remaining capacity ratio of a server and that of a route for a plurality of combinations of a server and a route and a step of selecting at least a server and a route to the server according to the computed products of multiplication.

Preferably, the service selecting step includes a step of acquiring load information, or the change in the remaining capacity ratio, on a predetermined server and that of a route to the server in case of receiving a unit number of connection requests; and a step of computing the remaining capacity ratio according to the change in the remaining capacity ratio, the remaining capacity ratio according to the acquired load information and the change in the number of connection requests when receiving a connection request from the client.

Preferably, the service selecting step includes a step of computing the difference in the products of multiplication of the remaining capacity ratios before and after the reception of the connection request and a step of selecting at least a server and a route to the server according to the difference value.

Preferably, in the data relay method according to the invention, the step of acquiring the change in the remaining capacity ratio includes a step of collecting load information at a first time point and the number of connection requests at the first time point, a step of collecting load information at a second time point and the number of connection requests at the second time point and a step of computing the load information on a predetermined server and a route to the server or the change in the remaining capacity ratio in case of receiving a unit number of connection requests according to the respective differences between the load information and the number of connection requests collected at the first time point and the load information and the number of connection requests collected at the second time point.

Preferably, the service selecting step acquires the ratio of utilization of each of the resources related to the load information, weighting the resource utilization ratio by introducing function F, using the resource utilization ratio as parameter xi, and computes the remaining capacity ratio by means of 1−F(xi).

Preferably, the data relay method according to the invention further comprises a step of monitoring the product of multiplication of the remaining capacity ratio of a server and that of a route for a plurality of combinations of a server and a route and a step of judging that the combined resources are congested and switching to another route for communication connection if the monitored value falls under a predetermined value.

Preferably, the service selecting step further includes a step of selecting a server and a route to the server according to policy information defining assignment of services.

In another aspect of the present invention, there is provided a data relay program for causing a computer to execute it for a data relay apparatus arranged between a plurality of servers and a client in order to relay a connection request from the client to one of the servers, the program comprising: an information collecting step of collecting load information on the servers and load information on the respective routes from the data relay apparatus to the servers; and a service selecting step of selecting at least a server and a route to the server in response to the connection request from the client according to the load information collected by the information collecting step.

In still another aspect of the present invention, there is provided a service selection apparatus for selecting at least a server out of a plurality of servers and a route to the server, the apparatus comprising: an information collecting section for collecting load information on the plurality of servers and load information on the respective routes to the plurality of servers; and a service selecting section for selecting at least a server and a route to the server according to the load information collected by the information collecting section.

In still another aspect of the present invention, there is provided a service selection method for selecting at least a server out of a plurality of servers and a route to the server, the method comprising: an information collecting step of collecting load information on the plurality of servers and load information on the respective routes to the plurality of servers; and a service selecting step of selecting at least a server and a route to the server according to the load information collected by the information collecting section.

In a further aspect of the present invention, there is provided service selection program for causing a computer to execute a process of selecting at least a server out of a plurality of servers and a route to the server, the program comprising: an information collecting step of collecting load information on the plurality of servers and load information on the respective routes to the plurality of servers; and a service selecting step of selecting at least a server and a route to the server according to the load information collected by the information collecting section.

In the following description of preferred embodiments of the present invention, a data relay apparatus operates as a service selection apparatus according to the invention. A method of operating a service selection apparatus according to the invention as described below is to be used as a service selection method according to the invention, while a program for causing a computer to execute the operation as described below is to be used as a service selection program according to the invention.

### BRIEF DESCRIPTION OF THE DRAWINGS

FIG. 1 is a flow chart of the principle of operation of a data relay apparatus according to the invention and that of a service selection apparatus according to the invention;

FIG. 2 is a schematic functional block diagram of a data relay apparatus according to the invention;

FIG. 3 is a schematic block diagram of an embodiment of the present invention, showing the overall configuration thereof;

FIGS. 4A and 4B schematically illustrate the relationship between a server information table and route information tables that can be used for the purpose of the present invention, of which FIG. 4A is a schematic illustration of the configuration of a server information table and FIG. 4B is a schematic illustration of the configuration of route information tables;

FIG. 5 is a schematic illustration of a server information table;

FIG. 6 is a schematic illustration of a route information table that corresponds to the server information table of FIG. 5;

FIG. 7 is a schematic illustration of another server information table;

FIG. 8 is a schematic illustration of a route information table that corresponds to the server information table of FIG. 7;

FIG. 9 is a flow chart of the first operation of the service selecting section 5A of FIG. 3;

FIG. 10 is a flow chart of the second operation of the service selecting section that is different from the first operation of FIG. 9;

FIG. 11 is a flow chart of the third operation of the service selecting section that is different from the operations of FIGS. 9 and 10;

FIG. 12 is a flow chart of the fourth operation of the service selecting section that is different from the operations of FIGS. 9 through 11;

FIG. 13 is a graph illustrating weighting functions that can be used to obtain the resource utilization ratio for the purpose of the present invention;

FIG. 14 is a flow chart of the fifth operation of the service selecting section that is different from the operations of FIGS. 9 through 12;

FIG. 15 is a schematic block diagram of an exemplar system realized by applying the present invention, showing in detail the overall configuration thereof;

FIG. 16 is a schematic illustration of the packet formats that can be used in the respective routes shown in FIG. 15;

FIG. 17 is a schematic illustration of the internal functional configuration of the data relay apparatus 1 of FIG. 15;

FIG. 18 is a schematic illustration of a first example of server information table and route information table that corresponds to FIG. 15;

FIG. 19 is a schematic illustration of a second example of server information table and route information table that corresponds to FIG. 15; and

FIGS. 20A, 20B and 20C schematically illustrate systems realized by applying the present invention, of which FIG. 20A is a schematic illustration of a corporate information system and FIG. 20B is a schematic illustration of a distributed IDC (Internet data center), while FIG. 20C is a schematic illustration of a carrier system.

### BEST MODE FOR CARRYING OUT THE INVENTION

Now, the present invention will be described by referring to the accompanying drawings that illustrate preferred embodiments of the invention.

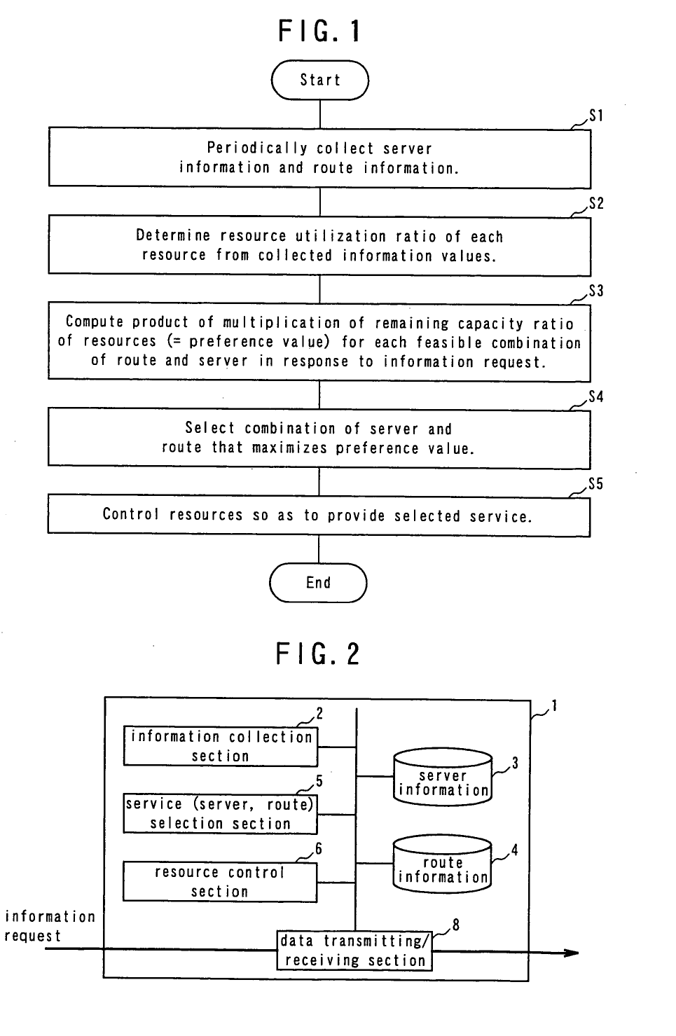

Firstly, the principle underlying the present invention will be described by referring to FIGS. 1 and 2. FIG. 1 is a flow chart of the principle of operation of a data relay apparatus according to the invention and that of a service selection apparatus according to the invention and FIG. 2 is a schematic functional block diagram of a data relay apparatus according to the invention. The data relay apparatus 1 illustrated in FIG. 2 comprises an information collection section 2 that collects server load information (to be referred to as server information hereinafter) and route load information (to be referred to as route information hereinafter), a server information database 3 for storing the collected server load information, a route information database 4 for storing the collected route load information, a service selection section 5 that selects a server and a route as service according to the collected or stored information, a resource control section 6 that carries out various operations including converting the destination address of the server, selecting a router and specifying a network in order to provide the selected service and a data transmitting/receiving section 8 that operates for transmission/reception of data between a client (not shown) and the server.

FIG. 1 illustrates the operation of the data relay apparatus 1. Referring to FIG. 1, in the data relay apparatus 1, the information collecting section 1 periodically collects server information/route information (S1) and appropriately stores the collected information in the server information database 3 and the route information database 4. Then, the service selection section 5 computes the ratio of utilization of each of the resources (servers and routes) from the collected information (S2), determines the product of multiplication of the remaining capacity ratios of each of the resources (preference value) (S3) and selects the combination of a server and a route that maximizes the preference value (S4). Thereafter, the source control section 6 controls the resources so as to provide the service by means of the combination (S5) and transmits information from the data transmitting/receiving section 8 to the selected server by way of the selected route while it receives information from the server by way of the selected route.

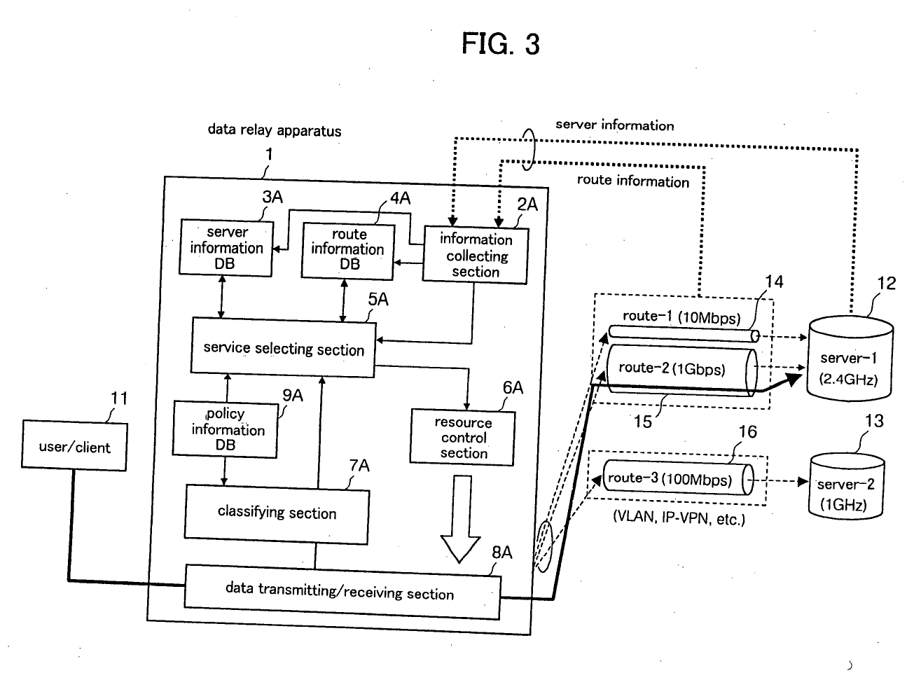

Now, an embodiment of the present invention will be described below. FIG. 3 is a schematic block diagram of a system comprising the embodiment, showing the overall configuration thereof. Referring to FIG. 3, the system comprises a user/client 11, various servers 12, 13, a data relay apparatus 1 arranged between the user/client 11 and the various servers 12, 13 and a plurality of routes 14, 15, 16. The data relay apparatus 1 by turn comprises an information collecting section 2A, a server information database 3A, a route information database 4A, a service selecting section 5A, a resource control section 6A, a classifying section 7A for classifying information requests in order to select services, a policy information database 9A storing policy information necessary for the classification and a data transmitting/receiving section 8A.

The information collecting section 2A periodically collects server information and route information. Server information may typically include CPU operating ratios and memory occupying ratios. Route information may typically include band occupying ratios and information on route delays.

The service selecting section 5A selects an appropriate service (server, route) to be assigned to the information request (connection request) from the user/client 11 according to the policy information (definition policy) stored in or appropriately input to the policy information database and the state information (server information, route information) collected by the information collecting section 2A.

The resource control section 6A controls the operation of selecting a server and a route in order to provide a selected (determined) service.

More specifically, for controlling the operation of selecting a route, it applies a label and selects an output interface in order to dynamically associate the received information request with a route of a VLAN or an IP-VPN.

For controlling the operation of selecting a server, it converts a virtual IP into a real IP that corresponds to each server.

The server information database 3A and the route information database 4A store respectively server information and route information as information tables. The information tables are designed to be used to control the server information to be assigned to the information request and the route information for getting to the server (a plurality of pieces of route information if there are a number of routes for getting to the server). The information collecting section 2A collects these pieces of information and writes them in the information tables of the databases 3A, 4A, which are referred to when the service selecting section 5A selects (determines) the service to be assigned to an information request.

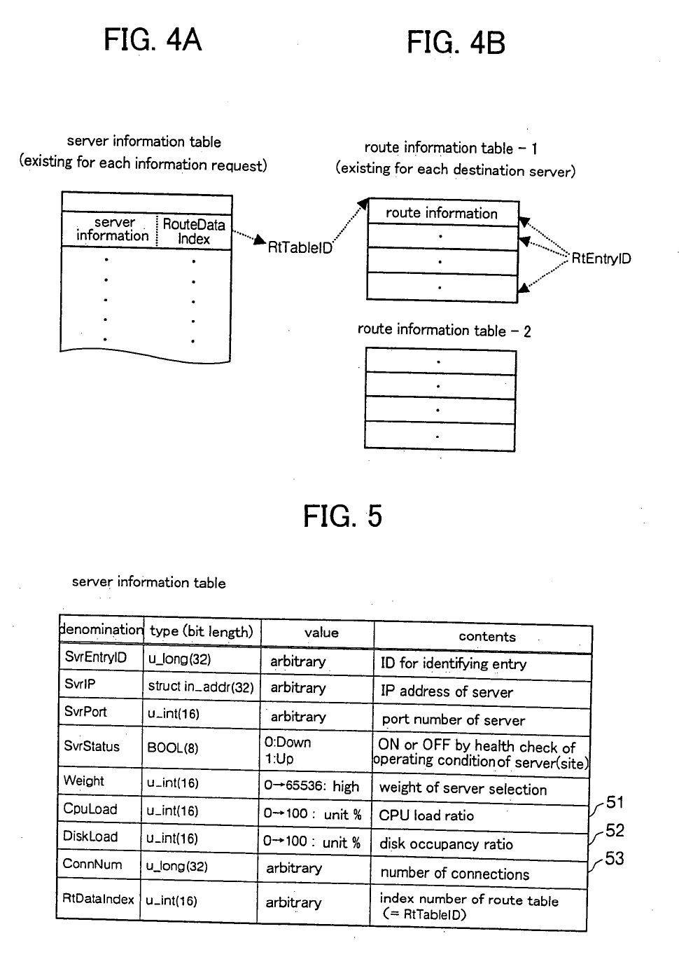

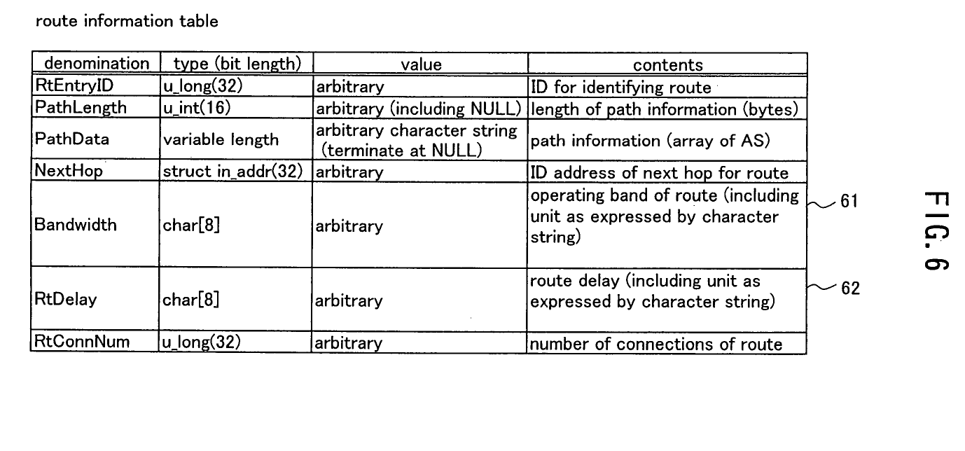

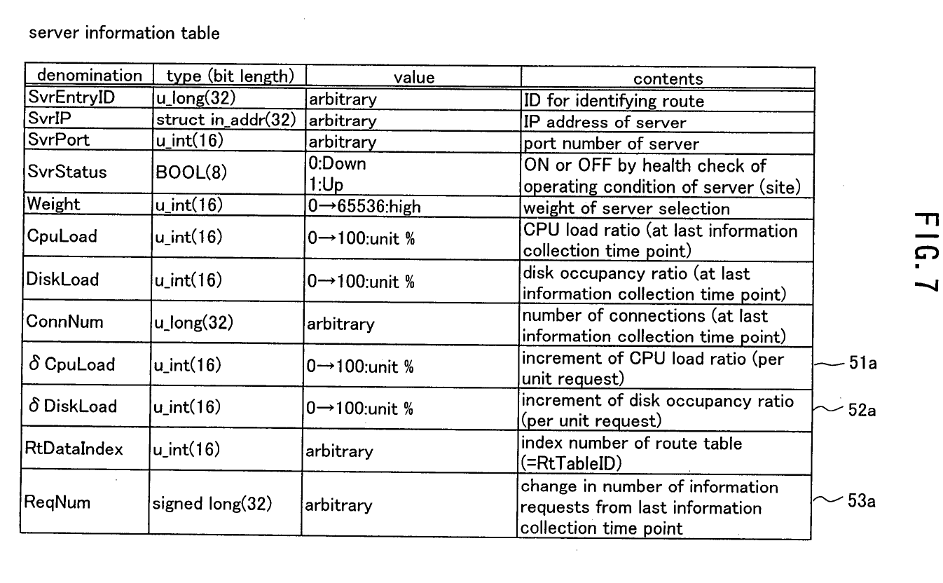

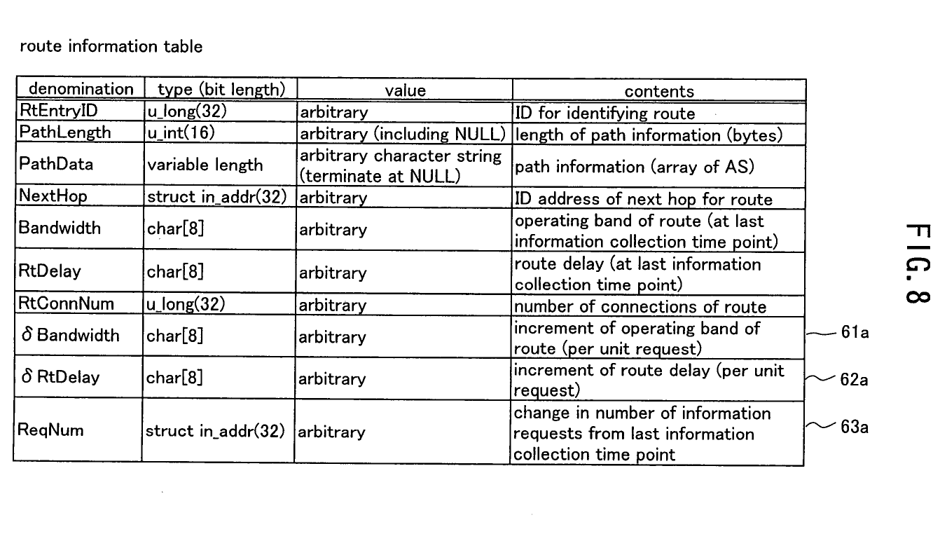

FIGS. 4A and 4B schematically illustrate the relationship between a server information table and route information tables, of which FIG. 4A is a schematic illustration of the configuration of a server information table and FIG. 4B is a schematic illustration of the configuration of route information tables. FIG. 5 is a schematic illustration of a server information table and FIG. 6 is a schematic illustration of a route information table that corresponds to the server information table of FIG. 5. FIG. 7 is a schematic illustration of another server information table and FIG. 8 is a schematic illustration of a route information table that corresponds to the server information table of FIG. 7.

Such a server information table is prepared for each piece of request information (for example, for each virtual IP address for a piece of request information) and contains a list of servers having the requested information and the load information of the servers. FIG. 5 shows that three categories of information including the CPU load ratio 51, the disk occupancy ratio 52 and the connection number 53 are collected.

As shown in FIG. 4B, a route information table is pointed from each entry of the corresponding server information table and contains a list of the routes for getting to the server and the load information of the routes. The route information table of FIG. 6 shows that two categories of information including the operating band 61 and the route delay 62. In this example, two or more than two routes for getting to the server are checked by means of the route searching feature of the BGP (border gateway protocol).

The server information table and the route information table shown in FIGS. 7 and 8 and those shown in FIGS. 5 and 6 differ from each other in that the former have the increment per unit request as a constant value or a rewritable value for information relating to the CPU load ratio and the disk occupancy ratio and the variation in the number of information requests from the last time point of collecting information as load information relating to connection information. More specifically, the server information table of FIG. 7 includes information of three categories including the increment 51a of the CPU load ratio, the increment 52a of the disk occupancy ratio and the variation 53a of the number of information requests from the last time point of collecting information as increments of variables and the route information table of FIG. 8 includes the increment 61a of the operating band, the increment 62a of the route delay and the variation 63a of the number of information requests from the last time point of collecting information as increments of variables.

(1st Operation)

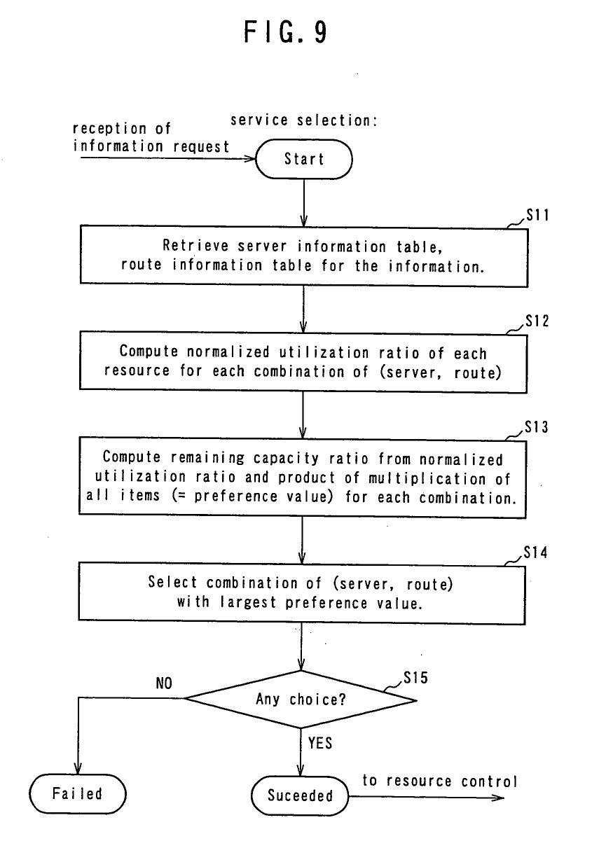

FIG. 9 is a flow chart of the first operation of the service selecting section 5A of FIG. 3. The service selecting section 5A operates, using the server information table and the route information tables as shown in FIGS. 4 through 6. Each time the data transmitting/receiving section 8A receives an information request from user/client 11, the service selecting section 5A retrieves the server information table and the route information tables relating to the requested information (S11). Then, it converts the load information contained in each table into a normalized resource utilization ratio of the resource, which takes a value between 0 and 1, for each possible combination of the server and one of the routes (S12). For the server load information shown in FIG. 5 and the route load information shown in FIG. 6, the normalized resource utilization ratio (the resource utilization ratio) is defined as follows for the computation. The CPU load ratio and the disk occupancy ratio are used as normalized utilization ratio without any modification when computing the normalized utilization ratio for the server load information. The connection number is determined by dividing the counted number of connections by the largest permissible number of connections. However, if the counted number of connections exceeds the largest permissible number of connections, the connection number is made equal to 1.

When computing the normalized utilization ratio for the route load information, the operating band is determined by dividing the measured operating band by the link speed and the route delay is determined by dividing the measured route delay by the largest permissible route delay. However, if the measured route delay exceeds the largest permissible route delay, the route delay is made equal to 1.

| | normalized utilization ratio |
|---|---|
| server load | |
| information | |
| CPU load ratio | →to be used without modification |
| disk occupancy ratio | →to be used without modification |
| connection number | →counted connection number/largest permissible |
| | connection number |
| | (however, if the counted number of connections |
| | exceeds the largest permissible number of |
| | connections, the connection number is made |
| | equal to 1) |
| route load information | |
| operating band | →measured operating bad/link speed |
| route delay | →measured route delay/largest permissible route |
| | delay (however, if the measured route delay |
| | exceeds the largest permissible route delay, the |
| | route delay is made equal to 1) |

Then, the remaining capacity ratio (1−normalized utilization ratio) is determined for each of the resources for each combination of a server and a route. Thereafter, the preference value Pn of the combination is computed as the product of multiplication of the remaining capacity ratios of all the load information. If the normalized utilization ratio of load information i is xi, the preference value Pn is expressed by the formula below:
Pn=(1−x1)(1−x2) . . . (1−xk),
where xi is the normalized utilization ratio of load information i.

Then, the service selecting section 5A compares Pns of all combinations of (server, route) and selects the combination showing the largest Pn value as service to be assigned to the information request. Then, it starts driving the resource control section 6A shown in FIG. 3 in order to control the actual resource. If there is no combination that satisfies the requirement, the information request is turned down because no appropriate resource exists.

(2nd Operation)

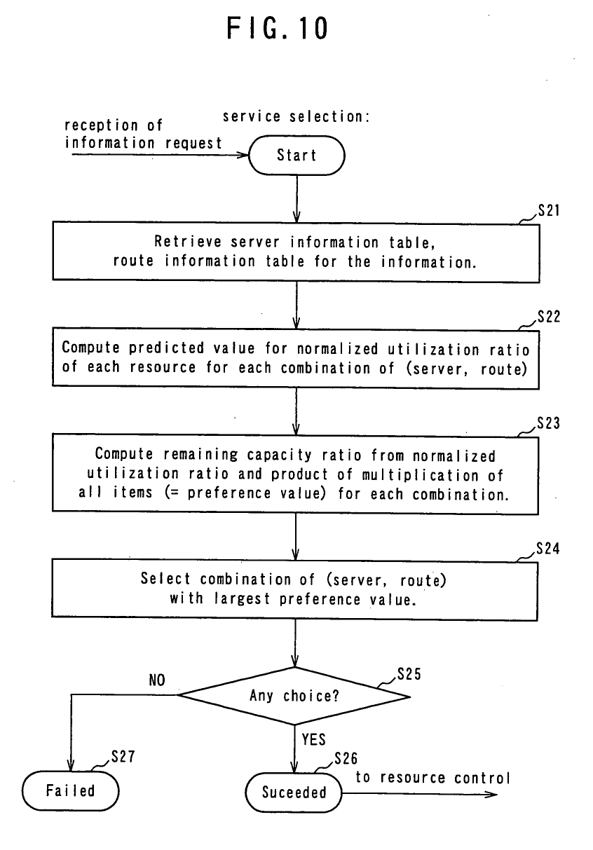

FIG. 10 is a flow chart of the second operation of the service selecting section that is different from the first operation of FIG. 9. The service selecting section 5A operates, using the server information table as shown in FIG. 7 and the route information table as shown in FIG. 8.

Each time the data transmitting/receiving section 8A receives an information request from user/client 11, the service selecting section 5A retrieves the server information table (FIG. 7) and the route information table (FIG. 8) relating to the requested information (S21). Then, it computationally determines the predicted value of the normalized utilization ratio of the resource (a value between 0 and 1) for the load information contained in each table (obtained at the last time point of collecting information) for each possible combination of a server and a route from the load information, the increment of the load per unit information and the increment of the number of information requests collected at the last time point (S22). If these values for the load information i are xi, dxi and m, the predicted value xi′ of the normalized utilization ratio of the load information including the one for the newly added information request is expressed by the formula shown below.

Assume here for the above operation that the increment of the load per unit information (dxi) is determined as constant value on the basis of actual measurements and registered in the server information table and the route information table of FIGS. 7 and 8 in advance.
xi′=xi+(m+1)×dxi

The remaining capacity ratio of each resource is computed by means of (1−predicted value of normalized utilization ratio) for each combination of (server, route) and then the preference value Pn′ is computed for the combination as product of multiplication of the remaining capacity ratios of all the load information (S23). If the normalized utilization ratio of load information i is xi, the predicted value Pn′ of the preference value is expressed by the formula below:
Pn′=(1x1′)(1x2′) . . . (1−xk′),
where xi′ is the predicted value of the normalized utilization ratio of load information i.

Then, the service selecting section 5A compares the Pn′ values of all combinations of (server, route) and selects the combination showing the largest value as service to be assigned to the information request (S24). Then, it starts driving the resource control section 6A shown in FIG. 3 in order to control the actual resource (S25Y, S26). If there is no combination that satisfies the requirement, the information request is turned down because no appropriate resource exists (S25N, S27).

(3rd Operation)

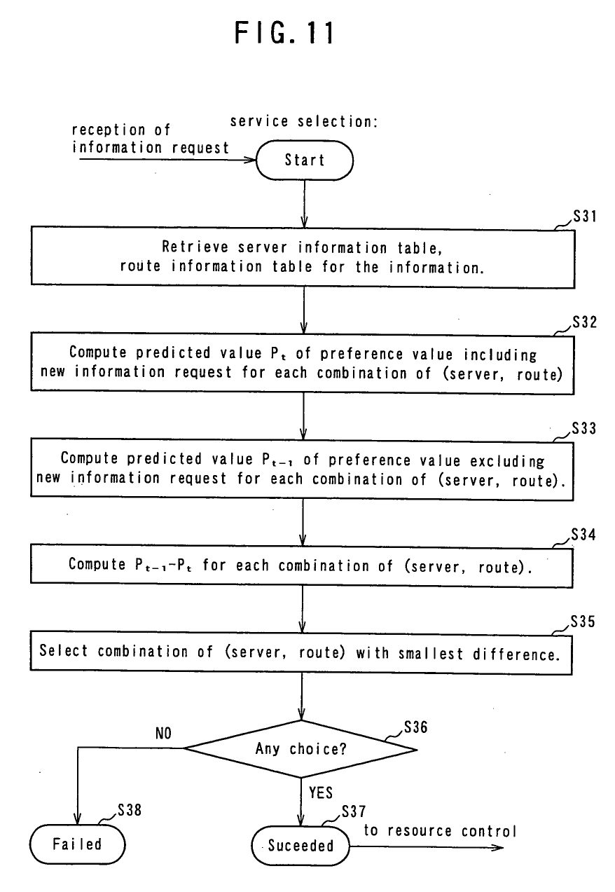

FIG. 11 is a flow chart of the third operation of the service selecting section that is different from the operations of FIGS. 9 and 10. The service selecting section 5A operates, using the server information table as shown in FIG. 7 and the route information table as shown in FIG. 8.

Each time the data transmitting/receiving section 8A receives an information request from user/client 11, the service selecting section 5A retrieves the server information table as shown in FIG. 7 and the route information table as shown in FIG. 8 for the requested information (S31). Then, it computationally determines the predicted values Pₜ(=Pn′) of the preference values for all combinations of (server, route) including the one for the newly added information request as described above for the second operation (FIG. 10) (S32). Then, it computes the predicted value Pₜ₋₁ of the preference value not including the one for the newly added information request (S33). Then, it computes the reduction in the predicted value of the preference value, or Pₜ₋₁−Pₜ (S34). Thereafter, it selects the combination showing the smallest value for the difference as service to be assigned to the information request (S35). Then, it starts driving the resource control section 6A shown in FIG. 3 in order to control the actual resource (S36Y, S37). If there is no combination that satisfies the requirement, the information request is turned down because no appropriate resource exists (S36N, S38).

(4th Operation)

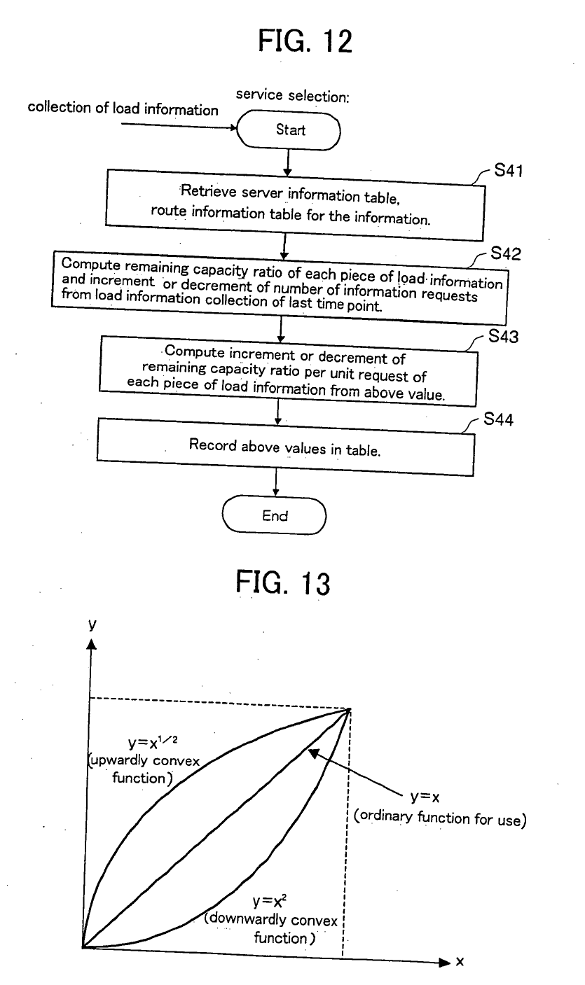

FIG. 12 is a flow chart of the fourth operation of the service selecting section that is different from the operations of FIGS. 9 through 11. The service selecting section operates, using the server information table as shown in FIG. 7 and the route information table as shown in FIG. 8.

For the fourth operation, a procedure for adaptively modifying the increment (dxi) per unit information request (connection request) of each piece of load information is defined on the basis of the load information that is periodically collected so that it differs from the second operation (FIG. 10) in which the increment is given as constant in advance.

In the fourth operation, each time new load information is collected, the service selecting section retrieves the server information table as shown in FIG. 7 and the route information table as shown in FIG. 8 for the requested information (S41). Then, it computes the remaining capacity ratio of each piece of load information and the increment or decrement of the number of information requests from the last time point of collecting load information (S42). Thereafter, it computes the increment or decrement of the remaining capacity ratio of each piece of load information per unit request from these values and the increment of the number of information requests (S43). For example, if the value of the load information collected at the last time point, the value of the load information collected this time and the increment of the number of information request are respectively x(i−1), x(i) and n for certain load information i, the new increment dxi is expressed by the formula below.
dxi=(x(i)−x(i−1))/n

The value determined by means of the above formula is then recorded in the server information table and the route information table (S44) and utilized as increment of the load information until new load information is collected at the next time point.

FIG. 13 is a graph illustrating weighting functions that can be used to obtain the above described resource utilization ratio. In other words, the illustrated curves are those of the functional formulas for determining the value to be used for the computation of a preference value in place of the actual resource utilization ratio. The load information value xi is converted into a weighting function y=Fi(x) and subsequently the preference value is computed for the combination of the service. In other words, the preference value Pn is expressed by the formula below:
Pn=(1−F1(x1)(1−F2(x2) . . . (1−Fk(xk)),
where xi is the normalized utilization ratio of the load information i.

FIG. 13 shows examples of weighting function F. Ordinary, y=x (or the normalized utilization ratio itself) is used. If it is intended to increase the influence of the load information, the intension can be realized by using the upwardly convex function of y=X^{1/2} for the function F. If, on the other hand, it is intended to decrease the influence of the load information, the intension can be realized by using the downwardly convex function of y=X² for the function F.

(5th Operation)

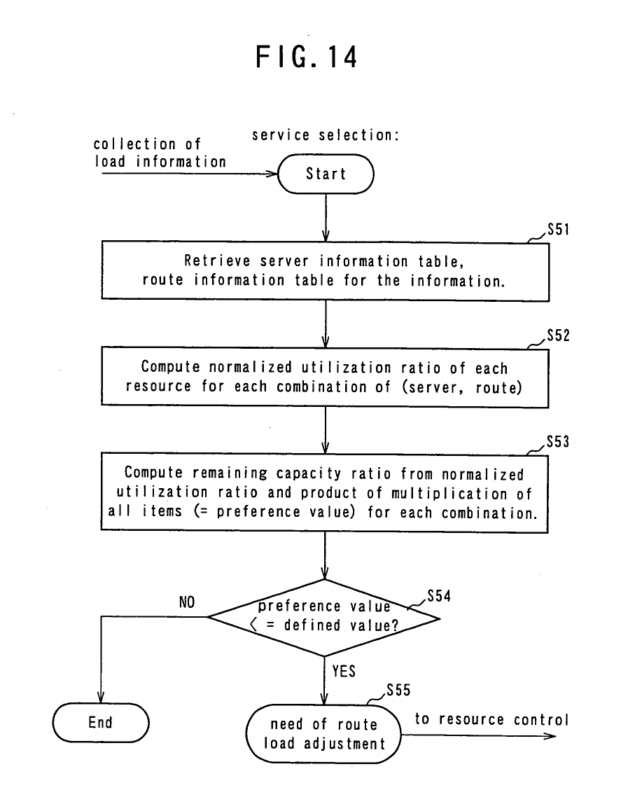

FIG. 14 is a flow chart of the fifth operation of the service selecting section that is different from the operations of FIGS. 9 through 12. The service selecting section 5A operates, using the server information table as shown in FIG. 5 and the route information table as shown in FIG. 6 or the server information table as shown in FIG. 7 and the route information table as shown in FIG. 8.

In the fifth operation, each time new load information is collected, the service selecting section 5A retrieves the server information table and the route information table for the load information (S51). Then, for each possible combination of the server and one of the routes the service selecting section 5A computes the normalized utilization ratio for the newly collected load information, following the procedure of the operation illustrated in FIG. 1 (S52). Then, it computes the remaining capacity ratio and, at the same time, the preference value for the combination in question (S53). Thereafter, it determines if the preference value is not greater than a predefined value or not (S54). If the preference value is not greater than the predefined value (S54Y), it judges that congestion takes place somewhere in the service and controls the route to the same server so as to partly switch the selected connection to some other route (alternative route) (rerouting) (S55). While the route control method used for this operation is not described in greater detail in this specification, it can be realized by means of alteration of the label to be applied to dynamically associating the information request with a route of a VLAN or an IP-VPN or alteration of the output interface to be selected.

(Exemplar System)

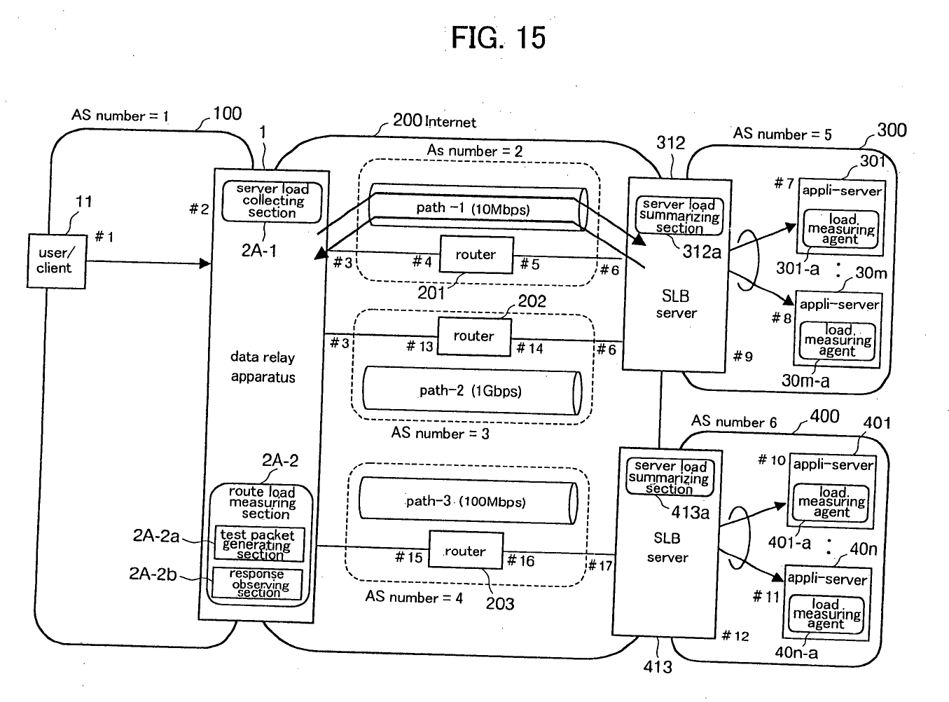

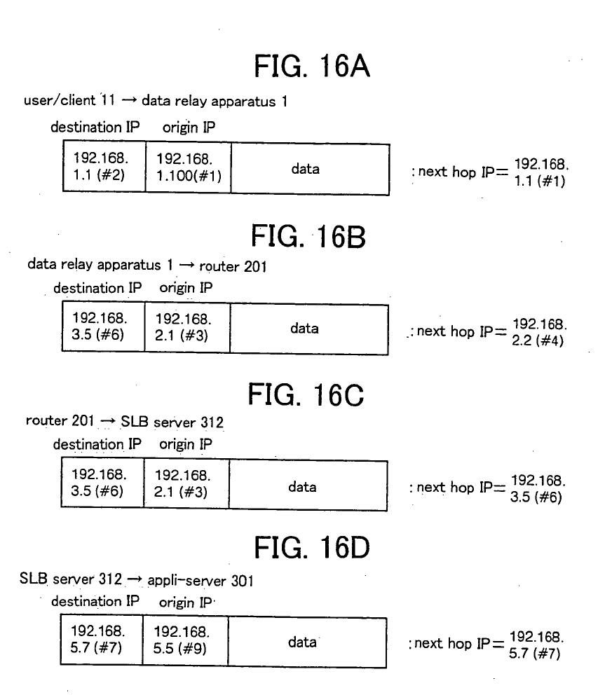

FIG. 15 is a schematic block diagram of an exemplar system realized by applying the present invention, showing in detail the overall configuration thereof. Referring to FIG. 15, access network 100 (e.g., regional strongpoint network) for accommodating the user/client 11 is connected to the Internet 200 by way of a data relay apparatus 1. On the other hand, information system sites 300, 400 storing information that can be provided to the user/client 11 are connected to the Internet 200 by way of SLB (session load balancer) servers 312, 413, and are adapted to internally distribute the server load to a plurality of appli-servers 301 through 30m. The information providing section that stores information is formed as a virtual one in two stages of the data relay apparatus 1 and the SLB servers 312, 413. In FIG. 15, IP addresses are indicated by #1 through #17. The packets transmitted from the user/client 11 to #2 (192.168.1.1) that is a VIP (virtual IP) are subjected to an IP address conversion for reassignment in the data relay apparatus 1 to VIP#6 of the SLB server (192.168.3.5 of the SLB server 312 in FIG. 16), which is the destination of reassignment, and transmitted to the SLB server 312, after specifying the route. Upon receiving the packets, the SLB server 312 conducts an IP address conversion for reassignment from VIP#6 (192.168.3.5) to the real IP of the appli-server to which the packets are reassigned (#7 of the appli-server 301 (192.168.5.7) in FIG. 16). Thus, they are transmitted to the appli-server 301. The route is controlled by specifying the next hop IP and transmitting the packets. There are two routes from the data relay apparatus 1 to the SLB server 312, one that passes the router 201 (#4: 192.168.2.2) and one that passes the router 202 (#13: 192.168.2.3). The route to be taken is defined by transmitting the packets from the data relay apparatus to #4 (192.168.2.2) or #13 (192.168.2.3) for the next hop. There is only one route to the SLB server 413 (#17: 192.168.4.6) that passes the router 203 (#15: 192.168.2.4).

As for collection of server load information, load measuring agents 301-a through 30m-a, 401-a through 40n-a are arranged in the inside of the appli-servers 301 (#7: 192.168.5.7) through 30m (#8: 192.168.5.8), 401 (#10: 192.168.6.9) through 40n (#11: 192.168.6.10) to periodically measure the CPU load ratio and the disk occupancy ratio. These load measuring agents may be realized by agents of SNMP (simple network management protocol), which provides standards for network management, or a program designed to read internal registers by means of sar, which is a standard tool of the UNIX type OSs. The appli-servers periodically report the data they obtain periodically to the SLB servers. Upon receiving the report, each of the SLB servers summarizes the load information received from the plurality of appli-servers so as to synoptically illustrate the entire site (by means of a server load summarizing section) and periodically report the synopsis illustrating the entire site to the data relay apparatus as load information representing the entire site. For summarizing, the simple average is used for the CPU loads and for the disk occupancy ratios and the total sum is used for the connections.

| | |
|---|---|
| CPU load ratios | →simple average |
| disk occupancy ratios | →simple average |
| connections | →total sum |

The data relay apparatus 1 has an information collecting section 2A, which includes a server load collection section 2A-1, a route load measuring section 2A-2. As for server load information, the server load collecting section 2A-1 collects the information (summarized load information) that is collected by the server load collecting sections 312a, 413a of the SLB servers 312, 413 as load information of the server sites 300, 400.

As for route load, the route load measuring section 2A-2 includes a test packet generating section 2A-2a and a response observing section 2A-2b, of which the test packet generating section 2A-2a specifies a route (the next hop IP in FIG. 15) and transmits test packets (typically ICMP ECHO Request packets) and the response observing section 2A-2b observes the response (delay and throughput) and computationally determines the operating band and the delay of the specified route.

FIG. 16 illustrates packet formats that can be used for the routes illustrated in FIG. 15. Each of the packet formats is defined in terms of the destination IP, the origin IP and the next hop IP. The next hop IP is the IP of apparatus to which the packets are directly transmitted. The next hop IP is used to transmit MAC (media access control) packets to the MAC address for the next hop IP in the MAC layer, which is a lower layer relative to IR. The illustrated packet formats are used to exchange data in a manner as described above. In FIG. 16A shows a packet format from the user/client to the data relay apparatus and FIG. 16B shows a packet format from the data relay apparatus to the router 201, while FIG. 16C shows a packet format from the router 201 to the SLB server 312 and FIG. 16D shows a packet format from the SLB server 312 to the appli-server 301.

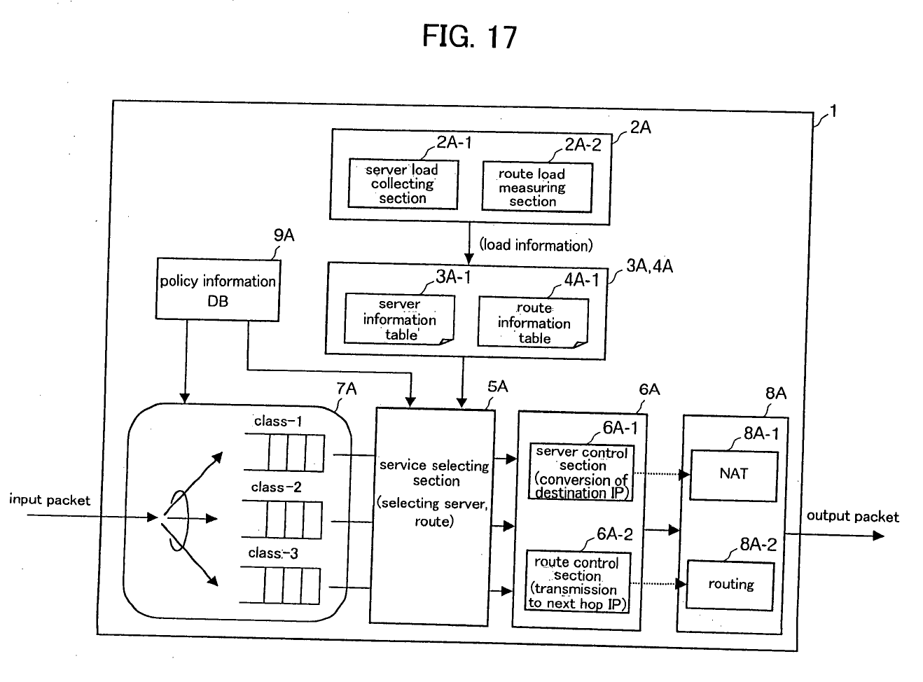

FIG. 17 is a schematic illustration of the internal functional configuration of the data relay apparatus 1 of FIG. 15. The input packets are sorted into a plurality of classes (packet queues) according to the classification policy predefined by the classifying section 7A. The service selecting section 5A selects a service (select a server and a route) according to the predefined service assignment policy and the collected load information (server load, route load). The resource control section 6A includes a server control section 6A-1 and a route control section 6A-2, and converts the transmitted destination IP into the destination IP of the selected server and delivers it to the NAT (functional section) 8A-1 of the data transmitting/receiving section 8A. The route control section 6A-2 adds the next hop IP that corresponds to the selected route and delivers it to the routing stack (functional section) 8A-2. The functional sections including the NAT 8A-1 and the routing stack 8A-2 perform the specified respective operations.

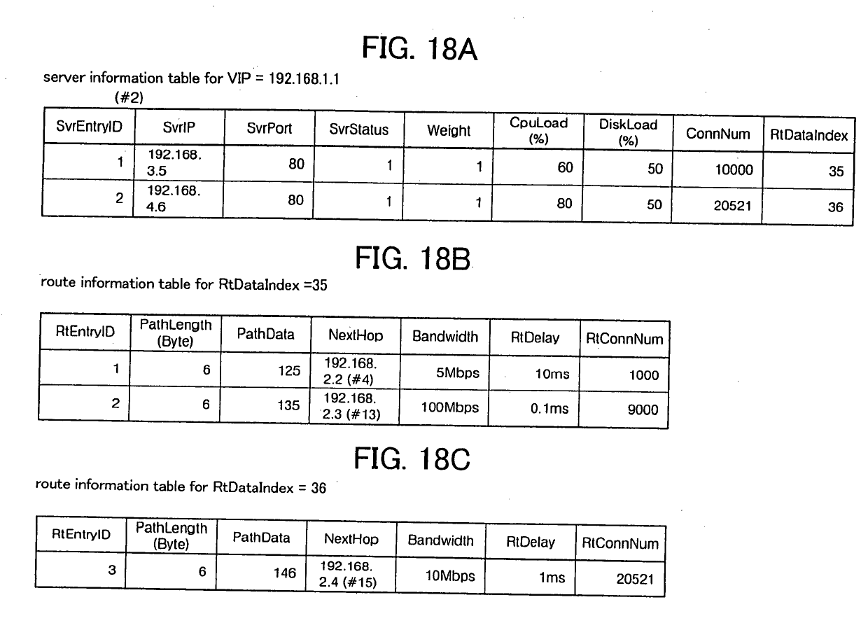

FIG. 18 is a schematic illustration of a first example of server information table and route information table that corresponds to FIG. 15, which correspond respectively to the formats of FIGS. 5 and 6.

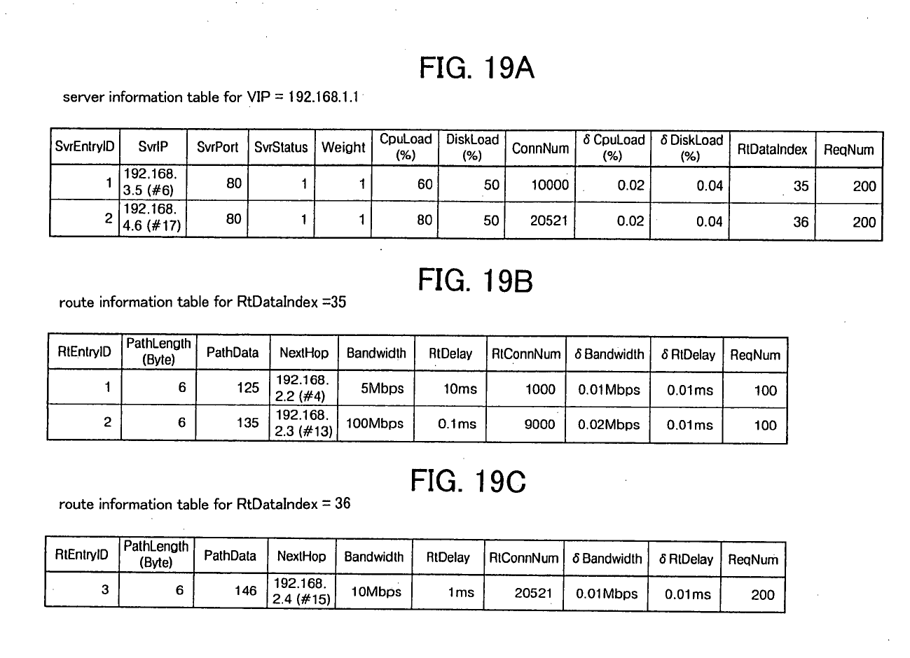

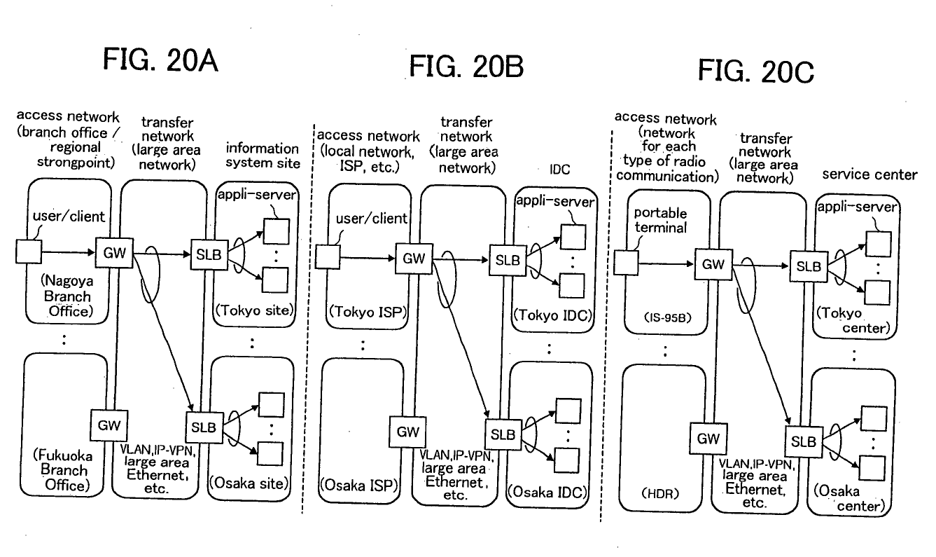

FIG. 19 is a schematic illustration of a second example of server information table and route information table that corresponds to FIG. 15, which correspond respectively to the formats of FIGS. 7 and 8.

Now, the operation of the arrangement of FIG. 15 will be described from the viewpoint of correspondence to the first through fifth operations illustrated in FIGS. 9 through 12 and 14.

(1st Corresponding Operation)

Firstly, the operation (exemplary operation 1) that corresponds to the first operation described above by referring to FIG. 9 will be described.

An information request is transmitted to the data relay apparatus 1 in the format illustrated in (a) of FIG. 16. In response to the information (#2 (192.168.1.1) as VIP), the service selecting section retrieves the server information table and the route information table illustrated in FIG. 18.

As a result, it will be found that there are three (server, route) combinations [to be indicated by (SvrEntryID, RtEntryID) in the tables hereinafter] including:
(1, 1), (1,2), (2, 3).
   Note that “1” for the server indicates the SLB server 312 (#6: 192.168.3.5) and “2” for the sever indicates the SLB server 413 (#17: 192.168.4.6), whereas “1” for the route indicates the path-1 (Router 201: #4), “2” for the route indicates the path-2 (Router 202: #13) and “3” for the route indicates the path-3 (Router 203: #15).

For the three combinations, the normalized utilization ratio of each resource is computed in a manner as shown below, using the three figures showing the CPU load ratio (CpuLoad), the disk occupancy ratio (DiskLoad) and the connection number (ConnNum) and the two figures showing the operating width (Bandwidth) and the route delay (RtDelay) that are computed respectively for server load information and route load information as parameters to be taken into consideration when selecting a service. It is assumed there that the largest permissible connections are 30,000 and the largest permissible delay is 100 ms.

(For example, the value of CpuLoad is used for the CPU load ratio and the connection number is computed by the formula of ConnNum/(largest permissible connections).)

Computation of normalized utilization ratio

| resource | CPU load | disk occupancy | |
|---|---|---|---|
| combination | ratio | ratio | connections |
| (1, 1) | 0.6 | 0.5 | 0.33 |
| (1, 2) | 0.6 | 0.5 | 0.33 |
| (2, 3) | 0.8 | 0.5 | 0.68 |

| operating band | route delay |
|---|---|
| 0.5 | 0.1 |
| 0.1 | 0.001 |
| 0.1 | 0.01 |

From the above normalized utilization ratios, the remaining capacity ratio of each resource and the product of multiplication of all the items (=preference value) are computed for each combination in a manner as described below. The remaining capacity ratio is 1−(normalized utilization ratio) and the preference value is the product of the remaining capacity ratios of all the items for each combination.

Computation of remaining capacity ratio and preference value

| resource | CPU load | disk occupancy | |
|---|---|---|---|
| combination | ratio | ratio | connections |
| (1, 1) | 0.4 | 0.5 | 0.67 |
| (1, 2) | 0.4 | 0.5 | 0.67 |
| (2, 3) | 0.2 | 0.5 | 0.32 |

| operating band | route delay | | preference value |
|---|---|---|---|
| 0.5 | 0.9 | → | 0.06030 |
| 0.9 | 0.999 | → | 0.12048 |
| 0.9 | 0.99 | → | 0.02851 |

Then, the combination of (1, 2) that maximizes the preference value is selected on the basis of the result of computations listed above. Since the preference value of the combination is not equal to 0, it is listed as effective choice and delivered to the resource control.

(2nd Corresponding Operation).

Now, the operation (exemplary operation 2) that corresponds to the second operation described above by referring to FIG. 10 will be described.

An information request is transmitted to the data relay apparatus 1 in the format illustrated in (a) of FIG. 16. In response to the information (#2 (192.168.1.1) as VIP), the service selecting section retrieves the server information table and the route information table illustrated in FIG. 19.

As a result, it will be found that there are three (server, route) combinations including:
(1,1), (1,2), (2,3).

For the three combinations, the predicted value of the normalized utilization ratio of each resource (including the one for the new information request) is computed in a manner as shown below, using the three figures showing the CPU load ratio (CpuLoad), the disk occupancy ratio (DiskLoad) and the connection number (ConnNum) and the two figures showing the operating width (Bandwidth) and the route delay (RtDelay) that are computed respectively for server load information and route load information as parameters to be taken into consideration when selecting a service. It is assumed there that the largest permissible connections are 30,000 and the largest permissible delay is 100 ms. (For example, the value of CpuLoad+d CpuLoad×(ConnNum+ReqNum+1) is used for the CPU load ratio.)

Computation of predicted value of normalized utilization ratio

| resource | CPU load | disk occupancy | |
|---|---|---|---|
| combination | ratio | ratio | connections |
| (1, 1) | 0.6402 | 0.5804 | 0.34 |
| (1, 2) | 0.6402 | 0.5804 | 0.34 |
| (2, 3) | 0.8402 | 0.5804 | 0.6907 |

| operating band | route delay |
|---|---|
| 0.601 | 0.1101 |
| 0.10202 | 0.0111 |
| 0.1201 | 0.0301 |

From the above prediction of the normalized utilization ratio, the predicted value of the remaining capacity ratio of each resource and the product of multiplication of all the items (=preference value) are computed for each combination in a manner as described below.

Computation of predicted value of remaining
capacity ratio and preference value

| resource | CPU load | disk occupancy | |
|---|---|---|---|
| combination | ratio | ratio | connections |
| (1, 1) | 0.3598 | 0.4196 | 0.66 |
| (1, 2) | 0.3598 | 0.4196 | 0.66 |
| (2, 3) | 0.1598 | 0.4196 | 0.3093 |

| operating band | route delay | | preference value |
|---|---|---|---|
| 0.399 | 0.8899 | → | 0.03538 |
| 0.89798 | 0.9889 | → | 0.08848 |
| 0.8799 | 0.9699 | → | 0.01770 |

Then, the combination of (1, 2) that maximizes the preference value is selected on the basis of the result of computations listed above. Since the preference value of the combination is not equal to 0, it is listed as effective choice and delivered to the resource control.

(3rd Corresponding Operation)

Now, the operation (exemplary operation 3) that corresponds to the third operation described above by referring to FIG. 11 will be described.

An information request is transmitted to the data relay apparatus 1 in the format illustrated in FIG. 16A. In response to the information (#2 (192.168.1.1) as VIP), the service selecting section retrieves the server information table and the route information table illustrated in FIG. 19.

As a result, it will be found that there are three (server, route) combinations including:
(1, 1), (1,2), (2, 3).
   For the three combinations, the predicted value Pₜ of the preference value including the new information request is computed by following the procedure defined for the second corresponding operation, using the three figures showing the CPU load ratio (CpuLoad), the disk occupancy ratio (DiskLoad) and the connection number (ConnNum) and the two figures showing the operating width (Bandwidth) and the route delay (RtDelay) that are computed respectively for server load information and route load information as parameters to be taken into consideration when selecting a service. It is assumed there that the largest permissible connections are 30,000 and the largest permissible delay is 100 ms.

Similarly, the predicted value Pₜ₋₁ of the preference value excluding the new information request is computed to determine Pₜ₋₁−Pₜ.

The obtained values are listed below for the three combinations.

Predicted value of preference value and difference value

| item combination | Pₜ | Pₜ₋₁ | Pₜ₋₁ − Pₜ |
|---|---|---|---|
| (1, 1) | 0.03538 | 0.03552 | 0.00014 |
| (1, 2) | 0.08848 | 0.08863 | 0.00015 |
| (2, 3) | 0.01770 | 0.01774 | 0.00004 |

On the basis of the above results of computations, the combination of (2, 3) that minimizes the difference of Pₜ₋₁−Pₜ is selected. Since the preference value of the combination is not equal to 0, it is listed as effective choice and delivered to the resource control.

(4th Corresponding Operation)

Now, the operation (exemplary operation 4) that corresponds to the fourth operation described above by referring to FIG. 12 will be described.

The server information table and the route information table as shown in FIG. 19 are retrieved at the timing of periodically collecting load information.

Assume here that the following is the newly collected load information.

Server load

| SvrEntryID | CpuLoad'(%) | DiskLoad'(%) | ConnNum' |
|---|---|---|---|
| 1 | 70 | 55 | 12000 |
| 2 | 82 | 55 | 21000 |

| | | | |
|---|---|---|---|
| RtEntryID | Bandwidth' | RtDelay' | RtConnNum' |

Route load of routes (path-1, path-2)

| | | | |
|---|---|---|---|
| 1 | 6 Mbps | 12 ms | 2000 |
| 2 | 110 Mbps | 0.2 ms | 10000 |

Route load of route (path-3)

| | | | |
|---|---|---|---|
| 3 | 12 Mbps | 1.2 ms | 21000 |

From the above listed values, the increments Δ from the load information (value in FIG. 19) obtained at the last time point of collecting load information are determined and listed below (e.g., ΔCpuLoad′=CpuLoad′−CpuLoad for the CPU load).

<Server load>

| SvrEntryID | ΔCpuLoad'(%) | ΔDiskLoad'(%) | ΔConnNum' |
|---|---|---|---|
| 1 | 10 | 5 | 2000 |
| 2 | 10 | 5 | 479 |

| | | | |
|---|---|---|---|
| RtEntryID | ΔBandwidth' | ΔRtDelay' | ΔRtConnNum' |

<Route load of routes (path-1, path-2)>

| | | | |
|---|---|---|---|
| 1 | 1 Mbps | 2 ms | 1000 |
| 2 | 10 Mbps | 0.1 ms | 1000 |

<Route load of route (path-3)>

| | | | |
|---|---|---|---|
| 3 | 2 Mbps | 0.2 ms | 479 |

From the above listed values, the increment d of each load information per unit request is as shown below (e.g., dCpuLoad′=ΔCpuLoad′/ΔConnNum′ for the CPU laod).

<Server load>

| SvrEntryID | dCpuLoad'(%) | dDiskLoad'(%) |
|---|---|---|
| 1 | 0.005 | 0.0025 |
| 2 | 0.021 | 0.0104 |

| | | |
|---|---|---|
| RtEntryID | dBandwidth' | dRtDelay' |

<Route load of routes (path-1, path-2)>

| | | | |
|---|---|---|---|
| 1 | 0.001 Mbps | 0.002 | ms |
| 2 | 0.01 Mbps | 0.0001 | ms |

<Route load of route (path-3)>

| | | |
|---|---|---|
| 3 | 0.0042 Mbps | 0.00042 |

The above d values are entered into the respective columns of dCpuLoad, dDiskLoad, dBandwidth and dRtDelay in the server information table and the route information table of FIG. 19 as the increment of new load information.

(5th Corresponding Operation)

Now, the operation (exemplary operation 5) that corresponds to the fifth operation described above by referring to FIG. 14 will be described.

The server information table and the route information table as shown in FIG. 19 are retrieved at the timing of periodically collecting load information.

Then, the predicted value of the normalized utilization ratio of each resource is computed for each combination of (server, route) by following the procedure defined for the second corresponding operation (although no predicted value for the new information request).

Similarly, the remaining capacity ratio is computed from the normalized utilization ratio by following the procedure defined for the first corresponding operation and the product of multiplication of all the items (=preference value) is determined for each combination. The obtained results are listed below.

<Computation of preference value>

| combination | preference value |
|---|---|
| (1, 1) | 0.03552 |
| (1, 2) | 0.08863 |
| (2, 3) | 0.01774 |

A value of 0.08 is used for the threshold value (defined value in Step S54 of FIG. 14) for the resource adjustment of the route. It is judged that congestion takes place somewhere in the service of the combination if the preference value falls below the threshold value for that combination.

By comparing the preference value and the threshold value for the two routes (1, 1) and (1, 2) that the same server has, it will be seen that the preference value of (1, 1) falls below the defined threshold value. Thus, the route load of the route (path-1) for getting to the server 312 needs to be reassigned to the route (path-2) for getting to the server 312.

(While the preference value for (2, 3) falls below the defined threshold value, the specified route is not switched because there is only one available route.)

Subsequently, an operation for controlling the resource is conducted and then an operation of switching the specified route to the route (path-2) takes place on a session by session basis.

### Industrial Applicability

As described above in detail, according to the invention, it is possible to select a server and a route according to the load information on servers and the load information on routes in order to effectively prevent degradation of data quality. Additionally, it is also possible to lead out a single evaluation reference value from a plurality of evaluation references obtained on the basis of the load information so that the choices can be compared with each other in a simple manner. Still additionally, it is possible to predict the next state and select an appropriate combination of a server and a route on the basis of the collected load information and the predicted values of utilization of resources. Thus, as a result, it is possible to effectively exploit resources and maintain the service quality.

1. A data relay apparatus to be arranged between a plurality of servers and a client in order to relay a connection request from the client to one of the servers, the apparatus comprising:
an information collecting section that collects load information on the servers and load information on the respective routes from the data relay apparatus to the servers; and
a service selecting section that selects at least a server and a route to the server in response to the connection request from the client according to the load information collected by the information collecting section.

2. The apparatus according to claim 1, wherein the service selecting section computes the remaining capacity ratio of each server and each route according to the load information and the product of multiplication of the obtained remaining capacity ratio of a server and that of a route for a plurality of combinations of a server and a route and selects at least a server and a route to the server according to the computed products of multiplication.

3. The apparatus according to claim 2, wherein the service selecting section acquires load information, or the change in the remaining capacity ratio, on a predetermined server and that of a route to the server in case of receiving a unit number of connection requests and computes the remaining capacity ratio according to the change in the remaining capacity ratio, the remaining capacity ratio according to the acquired load information and the change in the number of connection requests when receiving a connection request from the client.

4. The apparatus according to claim 3, wherein the service selecting section computes the difference in the products of multiplication of the remaining capacity ratios before and after the reception of the connection request and selects at least a server and a route to the server according to the difference value.

5. The apparatus according to claim 3, wherein the service selecting section computes and acquires the load information on a predetermined server and a route to the server or the change in the remaining capacity ratio in case of receiving a unit number of connection requests according to the respective differences between the load information and the number of connection requests collected at a first time point and the load information and the number of connection requests collected at the second time point.

6. The apparatus according to claim 2, wherein the service selecting section acquires the ratio of utilization of each of the resources related to the load information, weighting the resource utilization ratio by introducing function F, using the resource utilization ratio as parameter xi, and computes the remaining capacity ratio by means of 1−F(xi).

7. The apparatus according to claim 1, wherein the apparatus monitors the product of multiplication of the remaining capacity ratio of a server and that of a route for a plurality of combinations of a server and a route and, if the monitored value falls under a predetermined value, it judges that the combined resources are congested and switches to another route for communication connection.

8. The apparatus according to Claim 1, wherein the service selecting section selects a server and a route to the server according to policy information defining assignment of services.

9. The apparatus according to claim 1, wherein the load information on servers includes at least the CPU load ratio, the disk occupancy ratio or the connection number and the load information on routes includes at least the operating band or the route delay.

10. The apparatus according to claim 1, wherein the server is an SLB server comprising a server load summarizing section for summarizing the load information from a plurality of application servers.

11. A data relay method of a data relay apparatus arranged between a plurality of servers and a client in order to relay a connection request from the client to one of the servers, said method comprising:
an information collecting step that collects load information on the servers and load information on the respective routes from the data relay apparatus to the servers; and
a service selecting step that selects at least a server and a route to the server in response to the connection request from the client according to the load information collected by the information collecting step.

12. The method according to claim 11, wherein the service selecting step includes a step that computs the remaining capacity ratio of each server and each route according to the load information, a step that computs the product of multiplication of the obtained remaining capacity ratio of a server and that of a route for a plurality of combinations of a server and a route and a step that selects at least a server and a route to the server according to the computed products of multiplication.

13. The method according to claim 12, wherein
the service selecting step includes a step that aquires load information, or the change in the remaining capacity ratio, on a predetermined server and that of a route to the server in case of receiving a unit number of connection requests; and
a step that computs the remaining capacity ratio according to the change in the remaining capacity ratio, the remaining capacity ratio according to the acquired load information and the change in the number of connection requests when receiving a connection request from the client.

14. The method according to claim 13, wherein the service selecting step includes a step that computs the difference in the products of multiplication of the remaining capacity ratios before and after the reception of the connection request and a step that selects at least a server and a route to the server according to the difference value.

15. The method according to claim 13, wherein the step that aquires the change in the remaining capacity ratio includes a step that collects load information at a first time point and the number of connection requests at the first time point, a step that collects load information at a second time point and the number of connection requests at the second time point and a step that computs the load information on a predetermined server and a route to the server or the change in the remaining capacity ratio in case of receiving a unit number of connection requests according to the respective differences between the load information and the number of connection requests collected at the first time point and the load information and the number of connection requests collected at the second time point.

16. The method according to claim 12, wherein the service selecting step acquires the ratio of utilization of each of the resources related to the load information, weighting the resource utilization ratio by introducing function F, using the resource utilization ratio as parameter xi, and computes the remaining capacity ratio by means of 1−F(xi).

17. The method according to claim 11, further comprising:
a step that monitors the product of multiplication of the remaining capacity ratio of a server and that of a route for a plurality of combinations of a server and a route and a step that judges that the combined resources are congested and switching to another route for communication connection if the monitored value falls under a predetermined value.

18. The method according to claim 11, wherein the service selecting step further includes a step that selects a server and a route to the server according to policy information defining assignment of services.

19. A data relay program that causes a computer to execute it for a data relay apparatus arranged between a plurality of servers and a client in order to relay a connection request from the client to one of the servers, said program comprising:
an information collecting step that collects load information on the servers and load information on the respective routes from the data relay apparatus to the servers; and
a service selecting step that selects at least a server and a route to the server in response to the connection request from the client according to the load information collected by the information collecting step.

20. The program according to claim 19, wherein the service selecting step includes a step that computs the remaining capacity ratio of each server and each route according to the load information, a step that computs the product of multiplication of the obtained remaining capacity ratio of a server and that of a route for a plurality of combinations of a server and a route and a step that selects at least a server and a route to the server according to the computed products of multiplication.

21. The program according to claim 20, wherein the service selecting step includes:
a step that aquires load information, or the change in the remaining capacity ratio, on a predetermined server and that of a route to the server in case of receiving a unit number of connection requests; and
a step that computs the remaining capacity ratio according to the change in the remaining capacity ratio, the remaining capacity ratio according to the acquired load information and the change in the number of connection requests when receiving a connection request from the client.

22. The program according to claim 21, wherein the service selecting step includes a step that computs the difference in the products of multiplication of the remaining capacity ratios before and after the reception of the connection request and a step that selects at least a server and a route to the server according to the difference value.

23. The program according to claim 21, wherein the step that aquires the change in the remaining capacity ratio includes a step that collects load information at a first time point and the number of connection requests at the first time point, a step that collects load information at a second time point and the number of connection requests at the second time point and a step that computs the load information on a predetermined server and a route to the server or the change in the remaining capacity ratio in case of receiving a unit number of connection requests according to the respective differences between the load information and the number of connection requests collected at the first time point and the load information and the number of connection requests collected at the second time point.

24. The program according to claim 20, wherein the service selecting step acquires the ratio of utilization of each of the resources related to the load information, weighting the resource utilization ratio by introducing function F, using the resource utilization ratio as parameter xi, and computes the remaining capacity ratio by means of 1−F(xi).

25. The program according to claim 19, further comprising:
a step that monitors the product of multiplication of the remaining capacity ratio of a server and that of a route for a plurality of combinations of a server and a route and a step that judges that the combined resources are congested and switching to another route for communication connection if the monitored value falls under a predetermined value.

26. The program according to claim 19, wherein the service selecting step further includes a step that selects a server and a route to the server according to policy information defining assignment of services.

27. A service selection apparatus that selects at least a server out of a plurality of servers and a route to the server, said apparatus comprising:
an information collecting section that collects load information on the plurality of servers and load information on the respective routes to the plurality of servers; and
a service selecting section that selects at least a server and a route to the server according to the load information collected by the information collecting section.

28. A service selection method that selects at least a server out of a plurality of servers and a route to the server, said method comprising:
an information collecting step that collects load information on the plurality of servers and load information on the respective routes to the plurality of servers; and
a service selecting step that selects at least a server and a route to the server according to the load information collected by the information collecting section.

29. A service selection program that causes a computer to execute a process that selects at least a server out of a plurality of servers and a route to the server, said program comprising:
an information collecting step that collects load information on the plurality of servers and load information on the respective routes to the plurality of servers; and
a service selecting step that selects at least a server and a route to the server according to the load information collected by the information collecting section.
